(19) United States
(12) Patent Application Publication
(10) Pub. No.: US 2026/0357647 A1
(43) Pub. Date: Nov. 12, 2026

(54) APPARATUS AND METHOD FOR APPLYING A THERMOPLASTIC SPACER TO A GLASS SHEET

(71) Applicant: FOREL S.P.A. UNIPERSONALE, Roncade (Treviso) (IT)

(72) Inventors: Fortunato VIANELLO, Roncade (Treviso) (IT); Riccardo VIANELLO, Roncade (Treviso) (IT)

(21) Appl. No.: 19/125,039

(22) PCT Filed: Aug. 23, 2024
(86) PCT No.: PCT/IB2024/058212

§ 371 Date: Apr. 28, 2025

(30) Foreign Application Priority Data
Sep. 1, 2023 (IT) 102023000018015

(51) Int. Cl. E06B 3/673; E06B 3/663

(52) U.S. Cl. CPC E06B 3/6733; E06B 3/66328

(57) ABSTRACT

An apparatus for applying a thermoplastic spacer to a glass sheet has a lower support and a lateral support for the glass sheet, a nozzle and positioning elements for moving the nozzle with respect to the glass sheet, and feeding elements for feeding the nozzle with thermoplastic material. The apparatus has a pad positioned to act at a first section of thermoplastic material, with reduced thickness. An actuator moves the pad according to an axis (Z) perpendicular to a position of the lateral support, from a retracted position to an extracted position in which the pad is adapted to apply a pressure at the first section of thermoplastic material distributed on the glass sheet.

### FIELD OF APPLICATION

The present invention relates to an apparatus and method for applying a thermoplastic spacer for insulating glass. In particular, the present invention relates to a device for improving the adhesion of the thermoplastic spacer to a glass sheet with the elimination of a typical defect of the application methods of the prior art.

### BACKGROUND ART

As is known, insulating glass in the simplest configuration thereof consists of two glass sheets separated by a spacer which can be rigid, i.e., consisting of metal material, rigid polymer material or mixed metal-polymer material, or flexible supplied on coils, or finally made of thermoplastic material supplied in drums and extruded directly onto the glass through automated machines.

The present invention relates to the case of use of the thermoplastic spacer, for which its depositing onto a glass sheet is known, and the subsequent coupling to another glass sheet, to then seal the assembly on the entire outer periphery with a secondary sealant to form the so-called insulating glass.

It is also known that a multiple operation can be involved to obtain, for example, an insulating glass consisting of three glass sheets and two spacers, as well as “n” glass sheets and “n-1” spacers.

A brief description of the solutions commonly implemented for applying, by means of automated machines, the thermoplastic material for making the insulating glass useful in order to easily comprehend the disclosure below.

The extrusion of the thermoplastic material, according to manufacturers indications, must occur at a temperature close to 130 °C.

Preferably, the section of the spacer profile at the time of its extrusion onto the glass, is rectangular, and in order to ensure an adequate adhesion between the spacer and the glass, it is prescribed for the application to occur so that the dimension of the strip deposited onto the glass, in the direction perpendicular to the glass itself, be about 10% (up to 12%) greater than the final dimension desired, which height is achieved with the steps of assembling and pressing the insulating glass. Therefore, the section of the spacer in the final configuration takes the typical, slightly bulged shape of the sides not in contact with the glass, as shown in the diagrammatic and emphasized depiction in FIG. 1A.

One of the technical solutions for creating the junction between the initial and final parts of the strip of thermoplastic material, and also the most used solution by machine manufacturers, is described in WO96/09456.

With reference to FIGS. 2A-2D, which show a diagrammatic view of the method of the patent application mentioned above, the thickness of the thermoplastic material strip 3 extruded by a nozzle 10 is initially incremented from zero (FIG. 2A) to the desired thickness (FIG. 2B), and in a complementary manner, at the conclusion of the application (FIG. 2C), it decreases from the desired thickness to zero (FIG. 2D). With this solution, by utilising the extra material deposited and the subsequent pressing of the thermoplastic strip during the assembly of the insulating glass, two inclined and matching surfaces along the inclined plane 11 are obtained, which create the junction between the head and the tail of the spacer.

A subsequent evolution of the just introduced solution is disclosed in EP0823531A2. Such a document highlights the weak point of the solution described above, underlying that, as seen in FIGS. 3 and 4, in the point of initial deposition of the material, there is not a perfect contact with the material deposited in the final step of the process, but an empty area remains, indicated in FIG. 4 by reference numeral 12, which forms a possible passage for gases and moisture between the inside and the outside of the insulating glass. This defect is caused by the sudden slope variation between the final area of deposition of the thermoplastic material onto the glass and the inclined part of the material deposited according to the inclined plane 11. The solution suggested in EP0823531A2, shown in FIG. 5, consists in creating the initial section of thermoplastic material deposition, indicated by reference numeral 13 in the drawing, to then continue, as already described, with the inclined part 11 up to reaching the desired thickness. The initial section 13, with a thickness reduced by about a few tens of a millimetre, eliminates the sudden slope variation at the tip 12 of the first deposited section. Despite this, the problem can occur again in the starting point of section 13 albeit to a lesser extent, where there is no sudden slope variation of the deposited material, but a variation in thickness of a few tens of a millimetre is however involved-which values are sufficient for the creation of a defect such as to be a passageway for gases and moisture.

A further drawback relates to the application process: during the extrusion, in order to obtain good adhesion of the thermoplastic material to the glass, the fluid-dynamic thrust imparted to the material toward the glass due to the specific shape of the application nozzle is utilised. However, it is apparent that this thrust cannot be present in the first initial step of extrusion of the section 13 in FIG. 5 because the material is obviously initially stationary when the nozzle starts to be opened, and therefore the fluid-dynamic thrust due to the dynamics of the flow is not present. Moreover, given the small amount of the material moving along the entire section 13, the fluid-dynamic thrust can only be quite reduced, if not entirely absent in this section. The result is the non-consistent adhesion of section 13 in the initial part thereof, which simply rests on the glass, rather than adhering thereto.

Moreover, a further problem is the difficulty in controlling the extrusion when the amount of material to be processed is reduced, as in the case of section 13. The specific features of the thermoplastic material used are indeed to be considered, given that it is very sensitive to various factors, such as temperature, pressure, shear stress (note that these are the so-called non-Newtonian materials, i.e., the viscosity thereof varies as a function of the shear stress, and thus also of the flow rate), etc. In addition to this is the practice of starting the extrusion process first, imparting a relative movement between nozzle and glass, and only a few moments later commanding the opening of the nozzle and starting the deposition of the material. At this point, it is apparent that even if only one of the variables involved varies, there is a different behaviour and a varying delay with which the material reacts upon opening the nozzle. All this results in the lack of knowledge of the exact position of the initial part of section 13 by the control system of the machine. When the nozzle, at the end of its travel around the periphery of the glass, gets close to the initial section 13 and is about to conclude the application method by superimposing the thermoplastic material and that deposited beforehand, it must move away from the glass by a few tens of a millimetre in order to avoid interfering with the material of section 13 and drag it away from the glass, causing a serious defect on the end product. Such a need, combined with the lack of knowledge of the exact position of the initial point of section 13 by the control unit of the machine, makes it almost impossible to avoid the formation of a passage channel for gases and water vapor between the outside and the inside of the insulating glass. Such a defect cannot be eliminated even by the subsequent pressing that the unit undergoes during assembly.

The defect described above is acceptable, within certain well-defined limits, if the subsequent secondary sealing is provided, that even if is not as effective for all the materials used, can reduce the negative effects of such a type of defect and be a further obstacle to the penetration of moisture and passage of gases. The consequences instead are less acceptable, and therefore the need to find a solution is greater, should the secondary sealing not be provided, as described, for example, in WO2010111174A1 and shown in FIG. 1B, where the spacer made of thermoplastic material also fulfils the functions of the secondary sealing. Therefore, any defect on the thermoplastic spacer in this case directly affects the performance of the end product since there is no secondary barrier which can make up for such a deficiency.

### OVERVIEW OF THE INVENTION

Therefore, it is the object of the present invention to at least partially solve the drawbacks of the prior art.

It is a first task of the present invention to eliminate the drawbacks attributed to the prior art with an apparatus and method capable of allowing the extrusion of the thermoplastic spacer without the difficulty of creating an initial section characterised by the thickness being too small due to the features of the material and the machines usually dedicated to this processing.

At the same time, it is also a task to eliminate the defect encountered in the meeting point of the first section of deposited strip and the subsequent one when the junction is created between head and tail of the application.

In such a context, the aim to be achieved is also to allow the extrusion of the final section of thermoplastic spacer without the need to adapt too accurately the distance of the nozzle from the glass in the point in which the initial and final sections are superimposed, in the final processing step.

It is a further task to ensure an optimal adhesion to the glass, also over the first section of the extruded material.

Such needs are met, at least partially, by an apparatus for applying a thermoplastic spacer for insulating glass according to claim 1, and by a method for applying a thermoplastic spacer for insulating glass according to claim 12.

### DESCRIPTION OF THE DRAWINGS

Further features and advantages of the present invention will be more comprehensible from the following description of preferred, non-limiting embodiments thereof, in which:

FIG. 1A diagrammatically shows the section of an insulating glass 1 close to the peripheral edge, highlighting the glass sheets 2 and 2′, the thermoplastic spacer 3, and the secondary sealant 4;

FIG. 1B diagrammatically shows the section of an insulating glass 1 close to the peripheral edge if there is no secondary sealant, but the conventional functions of the latter are fulfilled by the thermoplastic spacer itself. The glass sheets 2 and 2′ and the thermoplastic spacer 3 are apparent;

FIG. 2A diagrammatically shows the section of an extruder nozzle 10 of thermoplastic spacer in the condition of approaching glass 2′ prior to starting the application process;

FIG. 2B shows the same nozzle after the first part of spacer 3 has been applied, with the creation of the inclined surface 11;

FIG. 2C shows the final step of the application process in which the extruder nozzle 10 is preparing to conclude the junction by superimposing the material in a manner complementary to what was done in the starting step;

in FIG. 2D, the junction is completed;

FIG. 3 shows (circled) the point where there is the sealing defect of the junction, as described in the prior art;

FIG. 4 is an enlargement of the area of the defect described in the prior art;

FIGS. 5A and 5B diagrammatically show two steps of a method for applying a thermoplastic spacer;

FIG. 6A diagrammatically shows a portion of a device for applying a thermoplastic spacer in a side view and in a resting condition;

FIG. 6B diagrammatically shows a side view of the device in FIG. 6A in an active condition;

FIG. 6C diagrammatically shows a side view of an application performed with a possible embodiment of a device for applying a thermoplastic spacer;

FIG. 7 diagrammatically shows a side view of an alternative embodiment of a device for applying a thermoplastic spacer, in an active condition; and

FIG. 8 diagrammatically shows an apparatus for applying a thermoplastic spacer according to a possible embodiment.

The elements or parts of elements common to the embodiments described below will be indicated by the same reference numerals.

### DESCRIPTION OF AN EMBODIMENT

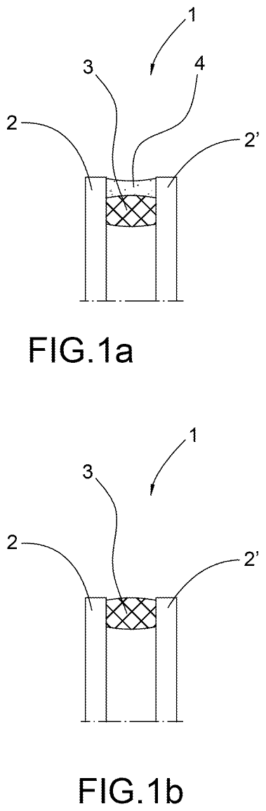

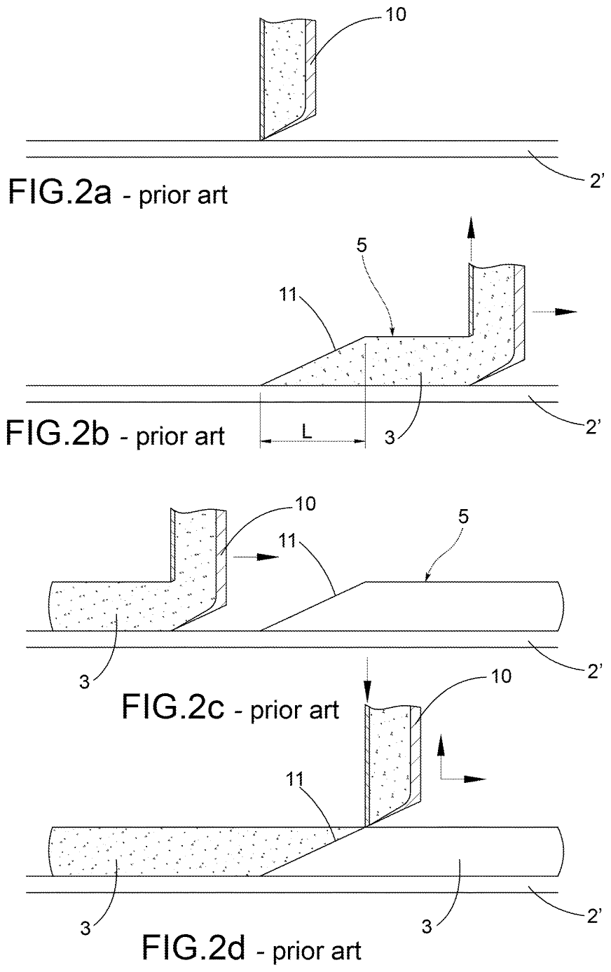

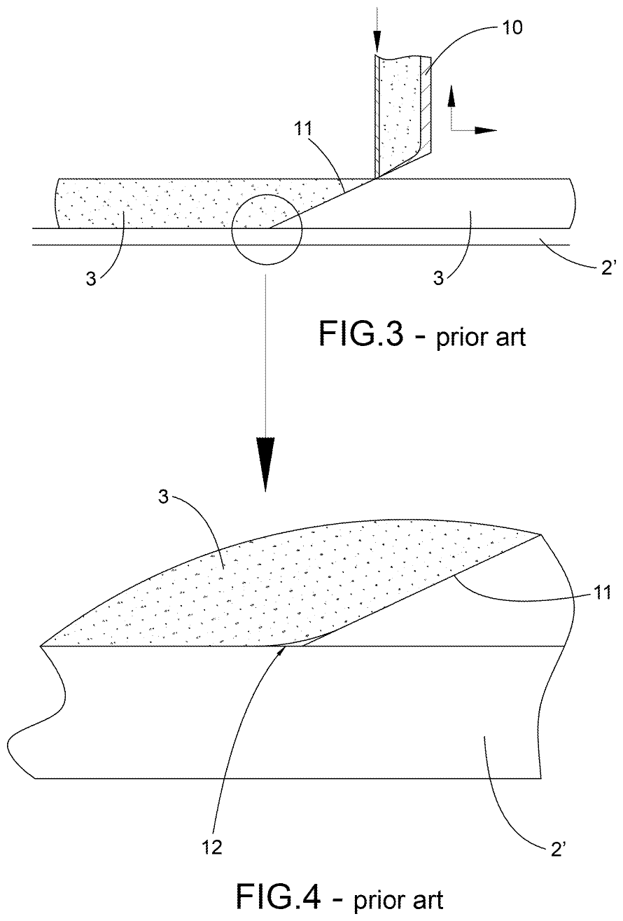

FIG. 1A shows the peripheral section of an insulating glass consisting of two glass sheets 2 and 2′, a thermoplastic spacer 3, and a secondary sealant 4. The entire following disclosure obviously also applies to the cases in which more than two glass sheets and more than one spacer are employed to make insulating glasses with more than one chamber. This type of embodiments is not shown, however they are well known to those skilled in the art.

FIG. 1B shows the particular case in which the insulating glass consists of the glass sheets 2 and 2′ and the spacer 3 in the absence of the secondary sealant. In this situation, the functions of the secondary sealant are performed by the spacer itself.

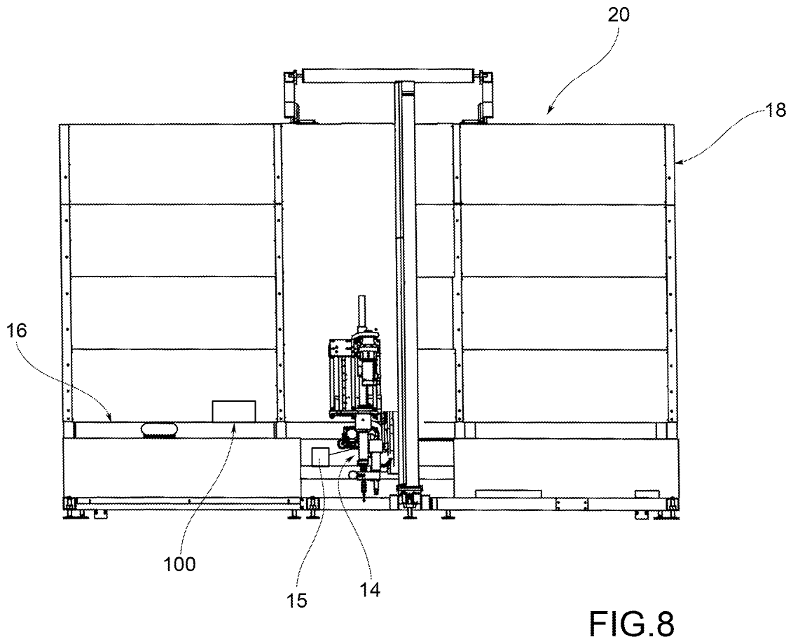

FIG. 8 shows an apparatus for applying a thermoplastic spacer to a glass sheet according to the present invention, indicated by general reference numeral 20.

Apparatus 20 comprises a lower support 16 and a lateral support 18 for a glass sheet 2′.

Moreover, apparatus 20 comprises a nozzle 10 and related positioning means 14 for moving the nozzle 10 with respect to sheet 2′, and feeding means 15 for feeding the nozzle 10 with thermoplastic material.

Apparatus 20 comprises padding means 100 comprising a pad 101 and actuator means 104 adapted to move the pad 101 according to an axis z substantially perpendicular to the arrangement of the lateral support 18, from a retracted position to an extracted position.

In the extracted position, the pad 101 is adapted to apply a pressure at a first section 13 of thermoplastic material distributed on the glass sheet 2′. In other words, the pad 101 is adapted to be moved close to (extracted position) and away from (retracted position) the lateral support 18, and in the extracted position, it has a distance from the lateral support 18 such as to allow an amount of thermoplastic material distributed on a sheet 2′ supported by the lateral support 18 to be at least partially crushed.

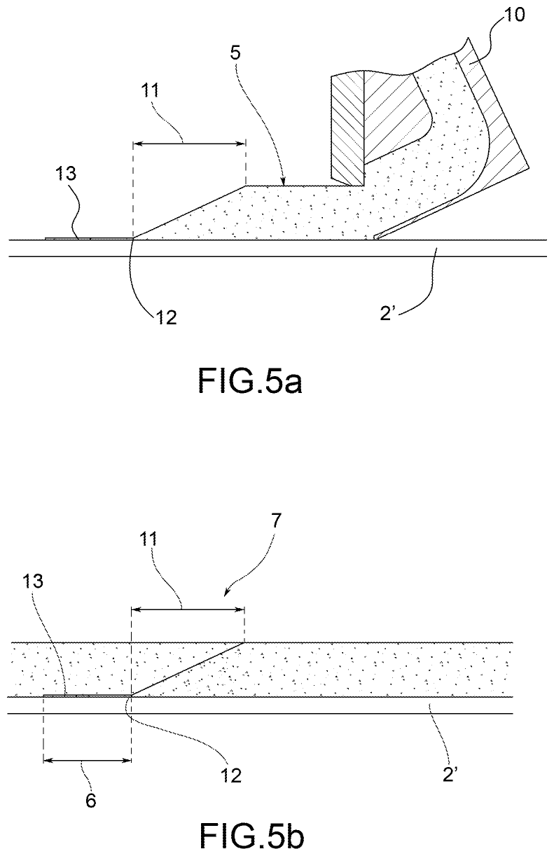

Therefore, the method for applying a thermoplastic spacer 3 to a glass sheet 2′ for making an insulating glass comprises the following steps:
(a) applying a first section 13 of thermoplastic material of reduced and substantially constant thickness by means of nozzle 10, as seen in the example in FIG. 5A;
(b) applying a second section 11 in which the thickness of the thermoplastic material gradually increases from the thickness of the first section 13 to the operating thickness;
(c) applying a third section 5 in which the thermoplastic material has an operating thickness;
(d) applying a fourth section 6 of thermoplastic material substantially superimposed on the first section 13 in which the thickness is substantially the same as that of step (c); and
(e) applying a fifth section 7 substantially superimposed on the second section 11 in which the thickness of the fifth section 7 gradually decreases until the closure of nozzle 10 so that the sum of the thicknesses of the second section 11 and the fifth section 7 is substantially equal to the operating thickness.

The method further comprises a step (f) in which the first section 13 is pressed towards the glass sheet 2′ through the pad 101 of the padding means 100 in the extracted position. Step (f) occurs before step (d).

In this disclosure, the term “operating thickness” means the thickness of the thermoplastic material prior to the coupling between the glass sheets 2 and 2′.

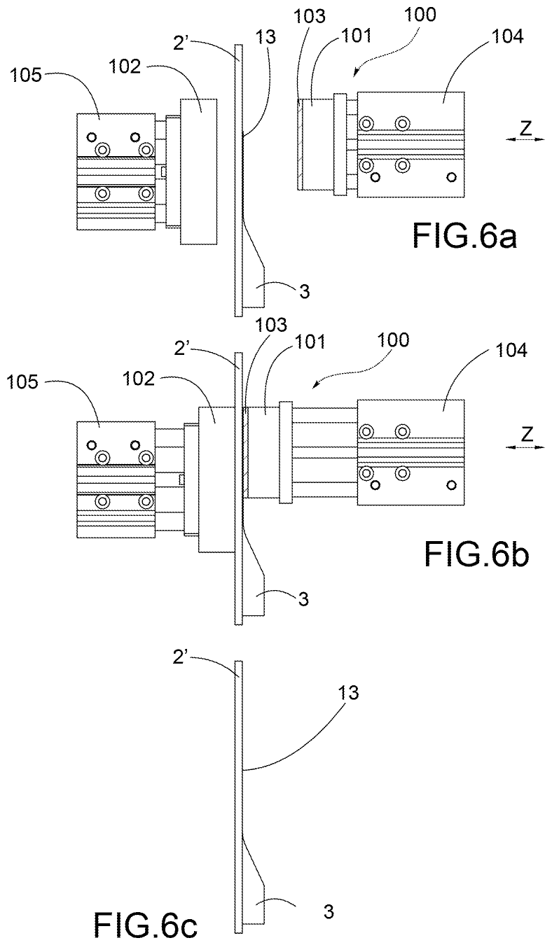

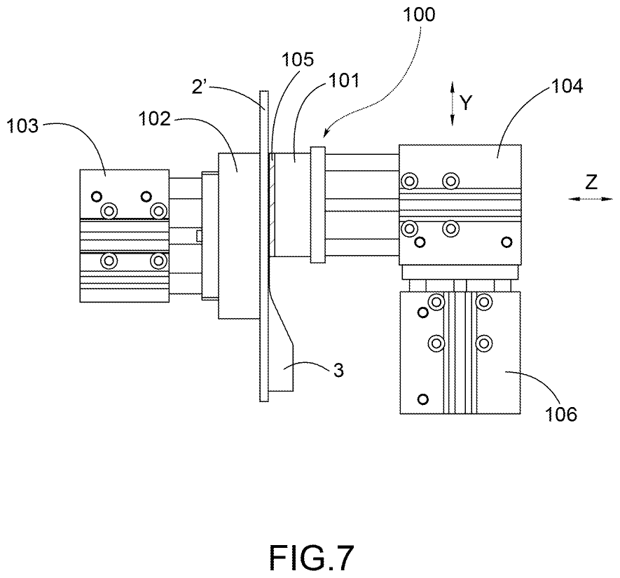

FIG. 6A shows a side view of a device implementing the invention, in which there is the glass 2′ where at least a first section 13 of reduced thickness of the thermoplastic spacer 3 has been deposited. Pad 101 is movable along axis Z, i.e., perpendicular to the glass 2′, and is in the retracted, or resting, position thereof. The actuator 104 is adapted to move pad 101 forward up to bringing it into contact with the first section 13 of the thermoplastic spacer 3 (extracted position), as shown in FIG. 6B.

The pad 101, pushed by the actuator 104, is thus capable of modifying the thickness of the first section 13 of the thermoplastic spacer 3, reducing it to a desired value.

Advantageously, the pad 101 can be covered, on the surface thereof intended to come into contact with the thermoplastic material, with an anti-adhesive material 103, e.g., polytetrafluoroethylene. It is thus avoided for the thermoplastic material to keep adhering with pad 101 during the step of retracting pad 101 to the retracted position.

Just as advantageously, the retracting movement of pad 101 from the extracted position to the retracted position can be performed so as to be very quick, always in order to avoid the thermoplastic material of the first section 13 from continuing to adhere to pad 101. Indeed, there is thus utilised the known property of this type of materials to slowly adapt to external stresses and, in the case of sudden detachment stresses, to keep adhering to the material with which the adhesion is generally greater, without breakages with parts of material which become detached and keep adhering to both parts as they move away.

According to a possible embodiment, said actuator means 104 can be adapted to move the pad 101 from the extracted position to the retracted position at a speed of at least 5 m/s.

Behind the glass sheet 2′ and at pad 101, an abutment 102 can be positioned, adapted to act substantially according to axis Z in antagonism with respect to the pad 101 to counteract the thrust of pad 101 against the glass sheet 2′.

According to a possible embodiment, the abutment 102 can comprise abutment actuator means 105 for moving the abutment 102 between a retracted position and an active position in which it approaches the pad 101 to support the glass sheet 2′ from the stress of pad 101. Stresses on the glass sheet are thus avoided, preserving the integrity thereof.

The actuator 105 can be pneumatic or of another type.

Alternatively, the abutment 105 can be replaced by a series of idle wheels with rotation axis parallel to axis Y. The same means used for translating the glass sheet 2′ along axis X, perpendicular to axis Z and axis Y, can also act as an abutment for countering the thrust of pad 101. Indeed, it is known that such translation means consist of a carriage with coupling systems of the glass sheet, typically consisting of suction cups that, when active, are capable of ensuring an adequate support surface to act as an abutment.

In addition to moving along axis Z, the pad 101 can be provided with means for moving it along axis Y, i.e., along the thermoplastic spacer application direction, for example through a second actuator (not shown in the accompanying drawings). Such a movement is actuated after pad 101 has been brought to the active position thereof and is crushing the thermoplastic material, and is performed in the direction opposite to that of application of the thermoplastic spacer in relation to glass 2′. The movement of pad 101 along direction Y aims to “spread” the thermoplastic material in order to make it even more adherent to the glass and reduce the thickness thereof even further.

The actuators 104, 105 and 106 can be of the double-acting pneumatic type or of the single-acting type with a spring return, which is capable of also serving the function of quick return of actuator 104, as specified above, or of the electric type.

The padding means 100 can comprise heating means 110, for example adapted to increase the temperature of the operating surface of pad 101 up to a temperature of around 130 °C.

It is thus possible to avoid the risk for contact with the pad 101 or with its material leading to a lowering in the temperature of the thermoplastic material and negatively affecting the behaviour thereof in the subsequent application steps.

The advantages which can be achieved by the present invention are thus apparent.

Firstly, the drawbacks attributed to the prior are eliminated with an apparatus and a method capable of allowing the extrusion of the thermoplastic spacer without difficulty in creating an initial section characterised by a thickness which is too small due to the features of the material and the machines usually dedicated to this processing.

At the same time, the defects encountered in the meeting point of the first section 13 of deposited thermoplastic material and the subsequent one are eliminated during the creation of the junction between head and tail of the application.

Moreover, the extrusion Of the final section of thermoplastic spacer is simpler given that there is no need to adapt too accurately the distance of the nozzle from the glass in the point in which the initial section and the final one are superimposed, in the final processing step.

Again, it is also possible to ensure an optimal adhesion to the glass for the first section 13 of extruded material.

In order to meet specific needs, those skilled in the art may make changes to the embodiments described above and/or replace the elements described with equivalent elements without departing from the scope of the appended claims.

1. An apparatus for applying a thermoplastic spacer to a glass sheet, the apparatus comprising a lower support and a lateral support for said glass sheet, a nozzle and relative positioning means for moving said nozzle with respect to said sheet, and feeding means for feeding said nozzle with thermoplastic material;
wherein the apparatus further comprises padding means positioned to act at a first section of thermoplastic material, with a reduced thickness, said padding means comprising a pad and actuator means adapted to move said pad according to an axis substantially perpendicular to a position of said lateral support, from a retracted position to an extracted position in which said pad is adapted to apply a pressure at the first section of thermoplastic material distributed on said glass sheet.

2. The apparatus of claim 1, wherein the actuator means are adapted to move the pad from said extracted position to said retracted position at a speed of at least 5 m/s.

3. The apparatus of claim 1, wherein the pad is covered, on its surface intended to come into contact with a material of the thermoplastic spacer, with an anti-adherent material.

4. The apparatus of claim 3, wherein the anti-adherent material is polytetrafluoroethylene.

5. The apparatus of claim 1, further comprising an abutment adapted to act substantially according to the axis (Z) in antagonism with respect to said pad to counteract a thrust of said pad against the glass sheet.

6. The apparatus of claim 5, wherein the abutment comprises abutment actuator means for moving said abutment between a retracted position and an active position in which the abutment approaches said pad to support the glass sheet from a stress of the pad.

7. The apparatus of claim 1, further comprising a series of idle wheels having a rotation axis parallel to an axis (Y), perpendicular to the axis (Z) and to an axis (X) along which the glass sheet is moved.

8. The apparatus of claim 1, wherein the padding means comprise a second actuator for moving said pad along an application direction of the thermoplastic spacer, but in an opposite orientation.

9. The apparatus of claim 1, wherein the actuator means are of double-acting pneumatic type or single-acting with spring return, or of electric type.

10. The apparatus of claim 1, wherein the pad comprises heating means.

11. The apparatus of claim 10, wherein the heating means are adapted to increase a temperature of the surface of the pad up to about 130 °C.

12. A method for applying a thermoplastic spacer to a glass sheet for making an insulating glass, the method comprising steps of:
(a) applying a first section of thermoplastic material of reduced and substantially constant thickness by a nozzle;
(b) applying a second section in which the thickness of the thermoplastic material gradually increases from the thickness of the first section to an operating thickness;
(c) applying a third section in which the thermoplastic material has the operating thickness;
(d) applying a fourth section, of thermoplastic material substantially superimposed on the first section in which the thickness is substantially the same as that of step (c); and
(e) applying a fifth section substantially superimposed on the second section in which the thickness of the fifth section gradually decreases until closure of the nozzle so that a sum of the thicknesses of the second section and the fifth section is substantially equal to the operating thickness;
wherein the method comprises a step
(f) in which the first section is pressed towards the glass sheet through said a pad in an extracted position;
step (f) being before step (d).

13. The method of claim 12, wherein actuator means are adapted to move the pad from said extracted position to a retracted position at a speed of at least 5 m/s.

14. The method of claim 12, characterised in that it comprises further comprising a step
(g) in which an abutment is driven which is adapted to act substantially according to an axis (Z) in antagonism with respect to said pad to counteract a thrust of said pad against the glass sheet.

15. The method of claim 14, wherein the abutment is moved between a retracted position and an active position in which the abutment approaches said pad to support the glass sheet from a stress of the pad thanks to abutment actuator means.

16. The method of claim 12, comprising a step in which the pad is moved along an axis (Y), in an opposite direction with respect to that of application of the thermoplastic spacer, after the pad has been brought into the extracted position and is in a step of crushing the thermoplastic material.
